(19) United States
(12) Patent Application Publication
(10) Pub. No.: US 2006/0158752 A1
(43) Pub. Date: Jul. 20, 2006

(54) Vehicle mirror

(75) Inventor: Jason Stephen Perkes, London (GB)

Correspondence Address: ANTHONY R. BARKUME, 20 GATEWAY LANE, MANORVILLE, NY, 11949, US

(73) Assignee: Russell Ambrose

(21) Appl. No.: 11/378,010

(22) Filed: Mar. 17, 2006

Related U.S. Application Data
(63) Continuation-in-part of application No. 10/480,976, filed on Dec. 15, 2003, now Pat. No. 7,040,772.

(51) Int. Cl. G02B 5/08

(52) U.S. Cl. 359/843; 250/206

(57) ABSTRACT

A mirror assembly for an articulated vehicle incorporates an image sensor which detects part of the trailer e.g. the end of the trailer, so that as the vehicle turns the image sensor maintains the image in its field of view and the mirror is automatically adjusted to maintain the driver's view of the part of the trailer in the mirror.

### CROSS-REFERENCE TO RELATED APPLICATION

This application is a continuation-in-part application of co-pending U.S. application Ser. No. 10/480,976, filed on Dec. 15, 2003 (PCT International Application PCT/GB02/02717 filed Jun. 14, 2002).

### FIELD OF INVENTION

The present invention relates to mirrors for use with vehicles, particularly with articulated lorries or trucks and vehicles towing trailers.

### BACKGROUND

The rear view for drivers on such vehicles is normally by side or wing mirrors which are mounted far enough forward from the driver to provide a field of vision down the sides of the vehicle and coupled trailer. Some of these mirrors also have smaller convex mirrors attached that help eliminate the “blind spot” that is present between the driver's view through the side-view mirrors and the driver's view out of the side of the vehicle. The views from these side-view mirrors and attached convex mirrors can be adequate when the vehicle and trailer are travelling straight ahead, but these views become obstructed when the vehicle makes a turn. When the vehicle turns, the path of the vehicle centerline changes with respect to the path of the coupled trailer centerline and the drivers view in the mirror on one side will be of the side of the coupled trailer, some distance forward of the rear end. This can drastically reduce the field of visibility of the driver and will result in a much larger blind area. This makes it difficult for the driver of the tow vehicle to navigate a turn, particularly when the turn is made toward the passenger side of the vehicle. The driver has no easy way to maintain a line of sight with the rear end of the trailer and possibly avoid any vehicles or obstructions that may be present in the adjacent lane.

With articulated vehicles a significant proportion of serious and fatal accidents occur where the left hand side of the vehicle is the first point of contact and in the majority of these accidents lack of visibility is at least a contributory factor. In driving schools for heavy goods vehicles there are special accident prevention courses to try to overcome this problem.

Attempts have been made to have mirrors which change their angle when the steering wheels of the vehicle are turned, but these involve complex mechanical linkages or additional sensors and have to be installed when the vehicle is built.

U.S. Pat. No. 6,151,175 discloses a device for maintaining a line of sight between a driver and a rear end of a trailer towed by a tow vehicle in which a transmitter and a receiver are coupled proximal a side-view mirror. A reflector is mounted proximal the rear end of the trailer and is adapted to receive a signal from the transmitter and to reflect the signal to the receiver. A control unit is provided for determining a deviation from an initial value of a selected property of the signal, the initial value corresponding to an orientation of the mirror when the line of sight is established.

In this device there has to be a signal sent out by a transmitter and reflected back and a complex processing system is employed to process the signals received. When it is to be fitted to a vehicle or trailer there has to be a reflector added to the vehicle or trailer and oriented or lined up with the transmitter and image sensor. This reflector has to be added to the trailer.

U.S. Pat. No. 5,706,144 and U.S. Pat. No. 6,397,137 disclose a system which involves sensing the driver's eyes and using this as the means to adjust a mirror; U.S. Pat. No. 6,193,380 discloses a system in which, if a vehicle is detected in the blind spot of a driver the wing mirror is automatically turned a pre-set amount so the driver can see the vehicle and, then the mirror automatically returned to its original position and JP 11-321495 discloses a system which detects when another vehicle comes into proximity of the driven vehicle and issues an alert to the driver.

None of these systems use the detection of a part of the vehicle or the trailer or part of the coupled trailer as it moves across the field of view of an image sensor.

### SUMMARY OF THE INVENTION

We have devised an improved self adjusting wing mirror which can easily be fitted to any vehicle including articulated heavy vehicles and does not involve additions to the vehicle or a trailer.

According to the invention there is provided a mirror assembly for a vehicle which mirror assembly incorporates (i) a mirror housing in which a mirror having a moveable reflective surface is mounted (ii) a mirror adjusting means capable of adjusting the orientation of the said reflective surface of the mirror (iii) an image sensing means attached to or forming part of the mirror housing, which image sensing means can detect a part of the vehicle or the trailer or part of a trailer connected to the vehicle (iv) a control system able to process signals from the image sensing means and which controls the mirror adjusting means and is able to adjust the orientation of the reflective surface of the mirror in response to movement of part of the vehicle or the trailer or part of a trailer as it moves across the field of view of the image sensing means.

The part of the vehicle or the trailer or part of a trailer which moves across the field of view of the image sensing means is normally that part seen in the reflective surface of the mirror. As the purpose of the image perceived by the image sensing means is only to detect the movement of a specific image, that being an image within which a trailer vehicle is visible, it has enhanced image recognition features to detect the image in which the trailer is present or moving. In most cases the ability to detect a contrast in colour or brightness, such as at an edge along the trailer is adequate and the specific image detected can be an area of such contrast e.g. the bed of the articulated section of the vehicle or a strip of bright or strongly reflective material stuck on the vehicle.

Alternatively there can be a light or other distinguishable feature fixed to the vehicle for detection and this forms the specific image. This feature or light will be already existing on the trailer and be considered a standard component or part of the trailer. The image sensing device focuses on part of the vehicle or trailer towards the rear of the vehicle or trailer and, unlike previous devices the image sensing device does not send out a signal, or respond to a signal transmitted by the indicator but only passively senses a visual image

The image sensing means is preferably a camera such as a CMOS camera or other image detector.

Preferably the image sensing means and the mirror are directly attached to each other e.g. the image sensing means can be rigidly attached to or mounted inside or outside the perimeter of the mirror housing so that adjustment of the mirror surface by the adjusting means cannot alter the position of the image sensing means.

In an embodiment of the invention the signal received by a camera is sent to a processor, which processor controls an actuator for the mirror. As the vehicle turns the image of the trailer or part of the trailer e.g. the end of the trailer moves across the field of view of the camera and a corresponding signal is sent to the processor, the processor then operates the actuator which turns the reflective surface of the mirror to maintain the view of the rear or part of the trailer in the drivers field of view of the mirror. This automatically means that the driver can see the rear of the vehicle as it turns.

The invention also provides a vehicle incorporating the mirror assembly and the invention is particularly useful in a vehicle which are towing a trailer, caravan, boat, horse-box etc. but is predominately useful for large vehicles and trucks.

It is an important feature of the invention that it can be readily fitted to a vehicle or trailer by simply replacing or adding a wing mirror and plugging the system into the vehicle electrical system for power. This cannot be done by any of the previous systems and gives a great advantage over other systems which have to be fitted when the vehicle is assembled or which involve complicated retrofitting procedures due to sensors fitted elsewhere in the vehicle or trailer.

In use, the mirror is adjusted automatically in the normal way to give the driver the appropriate view in the reflective surface of his mirror and the image sensing means is set up to detect a specific image of part of the trailer. When the vehicle turns, the part of the trailer will start to move across the field of view of the image sensing means, the image sensing means and processing means then causes the actuator to adjust the mirror so that the rear part of the trailer stays in its field of view so as to maintain the appropriate field of view of the rear of the vehicle or trailer in the mirror for the driver.

Preferably the signals received by the image sensing means are digitised and are an input into a computing element such as an electronic control unit etc. This computing element can control an actuator operating a moving means for the reflective surface of the mirror such as a motor, so that the orientation of the reflective surface is controlled thereby. There is also a positional feedback loop to inform the processing system of the orientation of the reflective surface of the mirror.

The system can incorporate other detection software so that it can detect other road users, obstacles, persons etc. and can cause a warning signal or sound when such other road users, obstacles, persons etc. are detected, the warning can be incorporated in the mirror or it can be in the driver's cab etc.

The mirror adjusting means can be any of the conventionally used means which are widely used on vehicles to electrically operate mirrors from inside the vehicle. In the present invention the orientation of the reflective surface of the mirror is controlled by the movement of an image of the trailer across the field of view of the image sensing means instead of by the driver of the vehicle using a manual switch.

By sensing the direction of travel of the vehicle using optical flow techniques from the images perceived by the image sensing means the system can modify the rate at which the orientation of the reflective surface is changed depending on vehicle direction.

As the length of a trailer can vary depending on the vehicle the length of the trailer is also able to be computed by the image sensing means and processing means so that the rate at which the orientation of the reflective surface is changed is adjusted accordingly.

There can be an indicator light which will be automatically activated when the mirror adjusting means and image sensing means are operating, this indicator light can be located at a convenient location e.g. in the mirror housing, on the dash board or elsewhere in the vehicle cab etc. The indicator light can be a steady light or it can flash in a manner similar to indicator lights.

Preferably the mirror assembly incorporates a means to transmit and receive additional data fitted in the driver's cab. This would enable there to be, for example, supplementary control of the whole vehicle turn indicator circuit. This could come into effect when articulation is sensed and can activate the suitable turn signals on the vehicle. The turn signals on the vehicle can be activated independently of hazard warning or reversing light circuits or in addition to these lighting circuits. If a combination of these lights are activated together and an input from the mirror system indicator is sensed then these lights may be flashed together or in a preprogrammed sequence.

If there is a remote or wireless link within the mirror this can also be used to transmit data between a companion mirror fitted the other side of the vehicle. A rolling code would be enabled such that adjacent mirror systems on different vehicles will not interfere with each other. The positional adjustment of the companion mirror may be controlled from the transmitting mirror if this feature is fitted or the companion mirror may have its own image sensor fitted for independent control.

Preferably there is a remote control switch fitted within the cab that allows the driver to override the mirror system at will. The signal transmitted from this switch to the mirror can be by a wireless link or can be wired into the vehicles existing electrically adjustable mirror circuit. The manual override control for the driver may also allow for a driver controlled up-down tilt adjustment of the mirror to accommodate different size drivers of the vehicle.

If the image sensing means is mounted above or below the mirror glass but still contained within the mirror housing, the housing may be required to have a slightly physical shape to accommodate the sensor in the lower or upper region of the mirror housing.

The invention is illustrated in the accompanying drawings in which:

### BRIEF DESCRIPTION OF THE DRAWINGS

FIG. 1 shows an articulated vehicle driving straight

FIG. 2 shows an articulated vehicle turning left using a conventional wing mirror

FIG. 3 shows an articulated vehicle turning left using an embodiment of the invention as a wing mirror

FIG. 4 shows the turning of the reflective surface of the mirror

FIG. 5 shows the mirror housing

FIG. 6 shows the mirror housing with added features

FIG. 7 is a three-dimensional view of the mirror housing

FIG. 8 is a schematic circuit diagram generally showing the circuit components which form a typical electronic circuit for accomplishing the automatic control of the mirror;

FIG. 9 is a schematic, logic diagram illustrating the steps in the start-up of the mirror control system

### DETAILED DESCRIPTION

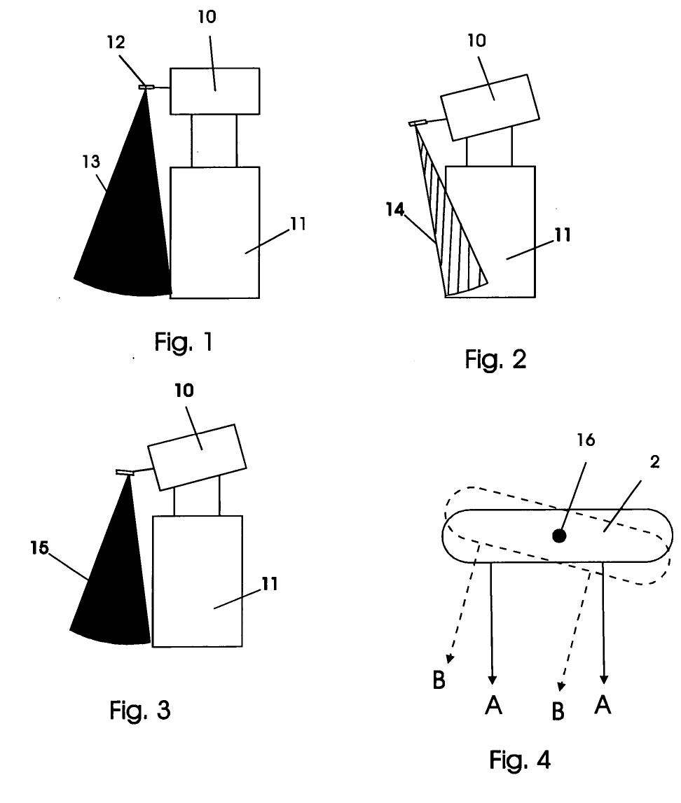

Referring to FIG. 1 this shows an articulated vehicle which comprises a driving section (10) towing a trailer (11) in which the driver's field of view in the left hand wing mirror (12) is shown by (13).

In FIG. 2 the vehicle is turning left and the driver's field of view is reduced to (14) so the driver's view is severely restricted.

In FIG. 3 with a wing mirror of the invention the reflective surface of the mirror is turned to expand the driver's field of vision to (15).

Referring to FIG. 4 this is a vertical view of the reflective surface (2) of the mirror and, as the mirror is turned about the axis (16) the field of view moves from A-A to B-B.

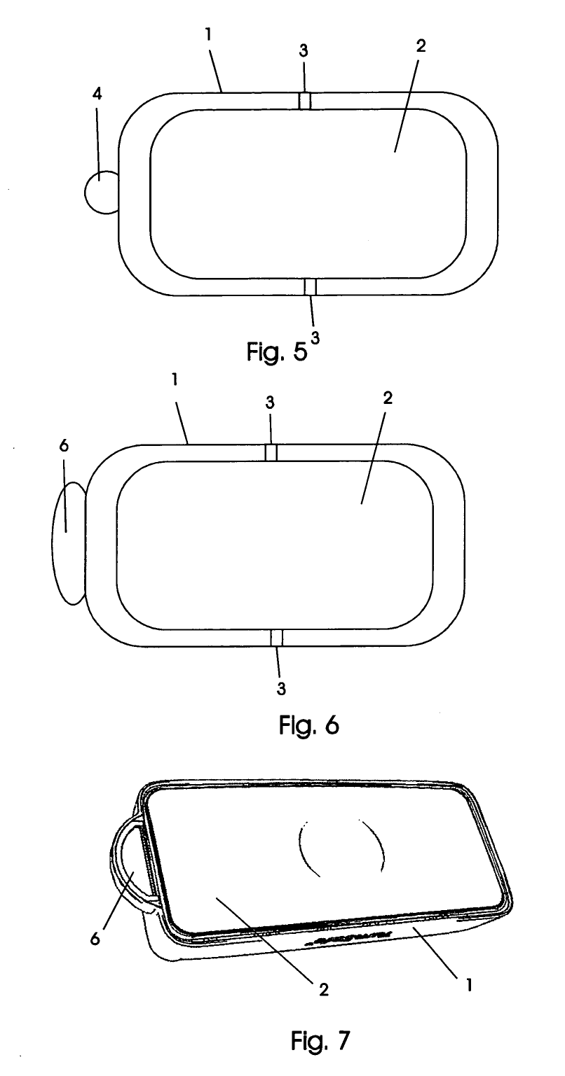

Referring to FIG. 5 a mirror assembly comprises a mirror housing (1) in which there is a reflective surface (2) mounted on bearings (3) and connected to a motor which can cause the reflective surface (2) to turn on the bearings (3). There is a camera (4) in the mirror housing.

In FIGS. 6 and 7 the module housing (6) which contains the camera also includes a transmitter which can transmit signals with additional data to modules that are integrated to the vehicle's electrical system. These signals enable there to be, for example, supplementary control of the whole vehicle turn indicator circuit which comes into effect when articulation is sensed and can activate the suitable turn signals on the vehicle.

There can be a remote link within the mirror to transmit data between a companion mirror fitted the other side of the vehicle.

In use the output from the camera (4) is fed to a microprocessor which controls the motor which turns the reflective surface (2) to control its orientation. As the towing vehicle turns the microprocessor controls the motor so that a specific image stays in the mirrors field of view and this automatically orients the reflective surface to maintain the driver's field of view.

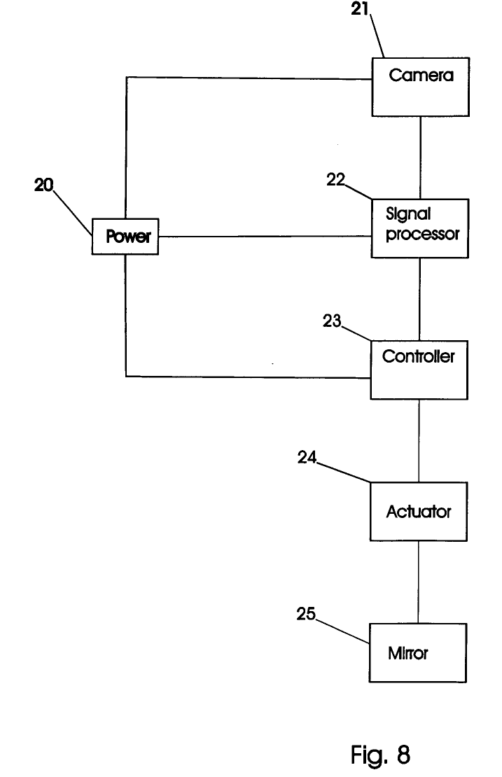

Referring to FIG. 8 this shows a system schematic layout for an embodiment of the invention. A power supply (20) which may be 12 or 24 volts such as typically supplied by the vehicle (10) (shown in FIG. 3) or may be provided by an auxiliary source such as a battery. The camera (21) is focussed towards the trailer (11) (FIG. 3) and produces a signal which is interpreted by a signal processor (22) that, in turn, sends an appropriate command to a controller (23). As the vehicle turns and the trailer moves across the field of view of the camera (21), the controller (23) directs the actuator (24) to turn the reflective surface of the mirror (25) by an amount which maintains the line of sight of the rear of the trailer in the mirror as seen by the driver. Although shown separately the camera (21) is in the mirror housing of the reflective surface (25).

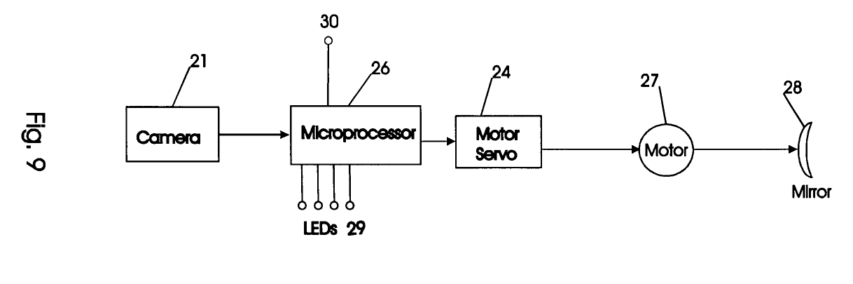

Referring to FIG. 9, in this embodiment the signal from the camera (21) is fed to the microprocessor (29) which acts as the signal processor and controller. Connected to the microprocessor are light emitting diode signal indicators (29) and a switch (30) controlled by the driver which can turn the system off. The microprocessor can also send signals to the wing mirror on the other side of the vehicle and to other devices if required.

In use the switch (30) is turned on and an indicator light (29) comes on telling the driver that the system is operable. The camera (21) is set to focus toward the trailer and a signal sent to the microprocessor (29). As the vehicle turns the trailer moves across the field of view of the camera and the corresponding signal sent to the microprocessor (26), the microprocessor turns on the actuator which operates the motor (27) which turns the reflective surface of the mirror (28) by an amount so that the field of view of the mirror covers the area along and behind the trailer. Although shown separately the camera (21) is in the mirror housing of the reflective surface (28).

What is claimed is:

1. A mirror assembly for a vehicle which mirror assembly incorporates (i) a mirror housing in which a mirror having a moveable reflective surface is mounted (ii) a mirror adjusting means capable of adjusting the orientation of the said reflective surface of the mirror (iii) an image sensing means attached to or forming part of the mirror housing, which image sensing means can detect a part of the vehicle or the trailer or part of a trailer connected to the vehicle (iv) a control system able to process signals from the image sensing means and which controls the mirror adjusting means and is able to adjust the orientation of the reflective surface of the mirror in response to movement of part of the vehicle or the trailer or part of a trailer as it moves across the field of view of the image sensing means.

2. A mirror assembly according to claim 1 in which the image sensing means is mounted within the perimeter of the mirror housing.

3. A mirror assembly according to claim 1 in which the image sensing means is mounted outside the perimeter of the mirror housing.

4. A mirror assembly according to claim 1 in which the image sensing means is a camera or a CMOS camera.

5. A mirror assembly according to 1 in which the mirror assembly incorporates a means to transmit additional data to modules that are integrated to the vehicle's electrical system by a means selected from direct cable connection, by infrared or wireless remote link.

6. A mirror assembly according to claim 1 in which there is an indicator light which is automatically activated when the mirror adjusting means and image sensing means are operating.

7. A mirror assembly according to claim 1 in which the control system includes a processing unit connected to the image sensing means and the signals received by image sensing means are an input into the processing unit.

8. A mirror assembly according to claim 7 in which the signal processing means is a processor and the signal received by the camera is sent to a processor, which processor controls an actuator for the mirror and, as the vehicle turns, the image of the trailer moves across the field of view of the camera and a corresponding signal sent to the actuator from the processor, the processor then operates the actuator which turns the reflective surface of the mirror to maintain the image of the rear of the trailer in the field of view of the mirror as seen by the driver.

9. A mirror assembly for a vehicle which mirror assembly incorporates (i) a mirror housing in which a mirror having a moveable reflective surface is mounted (ii) a mirror adjusting means capable of adjusting the orientation of the said reflective surface of the mirror (iii) an image sensing means selected from cameras and CMOS cameras rigidly attached to or forming part of the mirror housing, so that adjustment of the reflective surface by the adjusting means will not alter the position of the image sensing means, the image sensing means passively sensing the vehicle or trailer connected to the vehicle (iv) a control system connected to the image sensing means and which controls the mirror adjusting means and is able to adjust the orientation of the reflective surface of the mirror in response to movement of the indicator image across the field of view of the image sensing means.

10. A vehicle incorporating a mirror assembly according to claim 1.

11. A vehicle according to claim 10 in which there is a companion mirror on the other side of the vehicle to the mirror assembly and there is a remote link between the mirror assembly and companion mirror which can be used to transmit data therebetween.

12. A vehicle according to claim 11 in which the companion mirror has its own image sensor fitted for independent control.

13. A vehicle according to claim 12 in which there is a remote control switch fitted within the vehicle that allows the mirror system to be overridden.

14. A vehicle according to claim 13 which incorporates detection software able to detect other road users, obstacles, persons etc. and can cause a warning signal or sound when such other road users, obstacles, persons etc. are detected.

15. A vehicle incorporating a mirror assembly according to claim 9.
